(19) United States
(12) Patent Application Publication
(10) Pub. No.: US 2013/0107177 A1
(43) Pub. Date: May 2, 2013

(54) SELF-FOCUSING LIQUID CRYSTAL CELL AND CORRESPONDING LCD

(71) Applicant: Chihtsung Kang, Shenzhen (CN)

(72) Inventor: Chihtsung Kang, Shenzhen (CN)

(73) Assignee: SHENZHEN CHINA STAR OPTOELECTRONICS TECHNOLOGY CO., LTD., Sshenzhen, Guangdong (CN)

(21) Appl. No.: 13/380,878

(22) PCT Filed: Oct. 28, 2011
(86) PCT No.: PCT/CN2011/081477

§ 371 Date: Dec. 26, 2011

(30) Foreign Application Priority Data
Oct. 27, 2011 (CN) 201110331407.9

(51) Int. Cl. G02F 1/1335; G02F 1/1333; G02F 1/1343

(52) U.S. Cl. 349/102; 349/139; 349/138

(57) ABSTRACT

The present invention provides a self-focusing liquid crystal cell includes a first glass substrate, a upper transparent electrode, a liquid crystal layer, a lower transparent electrode and a second glass substrate. The upper transparent electrode is shaped as a semi-sphere, while the lower transparent electrode is a planar electrode. A distance between a center of the upper transparent electrode and the lower transparent electrode is smaller than that between periphery of the upper transparent electrode and the lower transparent electrode is greater; the liquid crystal layer is stuffed with negative nematic liquid crystals. The present invention also provides a liquid crystal display. The self-focusing liquid crystal cell and the liquid crystal display equipped with the liquid crystal lens controlled by applied voltage dynamically adjusts the focal length of the liquid crystal lens so as to provide the consistent variation of the gradient refractive index from all angles of view.

### BACKGROUND OF THE INVENTION

1. Field of the Invention

The present invention relates to liquid crystal display (LCD), and more particularly, to an LCD having a self-focusing liquid crystal cell capable of focusing depending on various viewing angles.

2. Description of the Prior Art

Naked-eye 3D technology proposes light signals from a panel to be refracted to corresponding locations for the sight of left and right eyes. Traditionally, lentical lens are used to form an optical path to match the required refractive index. One of the designs of lentical lens is to use a self-focusing grin lens with a gradient variation of refractive index as shown in FIG. 1, where x indicates a horizontal coordinate and n indicates a refractive index of the grin lens. As FIG. 1 shows, the refractive index of the grin lens is gradient variation, that is, the refractive index is greater in the center, while smaller in the side. Passing through the grin lens, the refracted lights are as condensed as by a hyperboloid lens.

However, the grin lens is incapable of adjusting its focal length according to viewers' position.

Therefore, the present invention provides a self-focusing liquid crystal cell and a corresponding LCD, capable of focusing depending on various viewing angles to realize 3D effect with adjustable focal length, in order to solve the above-mentioned problem occurring in the prior art.

### SUMMARY OF THE INVENTION

Accordingly, the present invention is to solve the technical problem, occurring in the prior art, that the grin lens is incapable of adjusting its focal length depending on the viewer's position, and an object of the present invention is to provide a design of liquid crystal lens controlled by applied voltage, which dynamically adjusts its focal length to realize a self-focusing liquid crystal cell of which the grin lens has the consistent performing capability of gradient refractive index from all angles of view.

According to the present invention, an liquid crystal display (LCD) comprises a first polarizer, a first liquid crystal cell, a second polarizer, and a self-focusing liquid crystal cell. The self-focusing liquid crystal cell comprises a first glass substrate, a upper transparent electrode, a liquid crystal layer, a lower transparent electrode, and a second glass substrate. The LCD comprises a λ/4 plate, located outside of the polarizer, transforming linearly polarized light into circularly polarized light; a incident side of the self-focusing liquid crystal cell is attached to an emitting side of the λ/4 plate. The upper transparent electrode is shaped as a semi-sphere, while the lower transparent electrode is a planar electrode, and a distance between a center of the upper transparent electrode and the lower transparent electrode is smaller than that between periphery of the upper transparent electrode and the lower transparent electrode; the liquid crystal layer is stuffed with negative nematic liquid crystals. A non-conductive polymer layer, which maintains the shape of the upper transparent electrode, is disposed between the upper transparent electrode and the liquid crystal layer. The negative nematic liquid crystals are arranged in a circle in a clockwise direction or a counter-clockwise direction by applying an electric field between the upper transparent electrode and the lower transparent electrode. When the emitting linearly polarized light is perpendicularly linearly polarized, an optical axis of the λ/4 plate is at 45 degree clockwise to the perpendicularly linearly polarized light. When the emitting linearly polarized light is horizontally linearly polarized, an optical axis of the λ/4 plate is at 45 degree counter-clockwise to the horizontally linearly polarized light.

According to the present, an LCD comprises a first polarizer, a second polarizer and a self-focusing liquid crystal cell. The self-focusing liquid crystal cell comprises a first glass substrate, a upper transparent electrode, a liquid crystal layer, a lower transparent electrode and a second glass substrate. The LCD also comprises a λ/4 plate, located outside of the polarizer, transforming linearly polarized light into circularly polarized light. An incident side of the self-focusing liquid crystal cell is attached to an emitting side of the λ/4 plate. The upper transparent electrode is shaped as a semi-sphere, while the lower transparent electrode is a planar electrode. A distance between a center of the upper transparent electrode and the lower transparent electrode is smaller than that between periphery of the upper transparent electrode and the lower transparent electrode is greater. The liquid crystal layer is stuffed with negative nematic liquid crystals.

In one aspect of the present invention, a non-conductive polymer layer, which maintains a profile of the upper transparent electrode, is set up between the upper transparent electrode and the liquid crystal layer.

In another aspect of the present invention, the negative nematic liquid crystals are arranged in a circle in a clockwise direction by applying an electric field between the upper transparent electrode and the lower transparent electrode.

In another aspect of the present invention, the negative nematic liquid crystals are arranged in a circle in a counter-clockwise direction by applying between the upper transparent electrode and the lower transparent electrode.

In another aspect of the present invention, when the emitting linearly polarized light is perpendicularly linearly polarized, an optical axis of a λ/4 plate is at 45 degree clockwise to the perpendicularly linearly polarized light.

In yet another aspect of the present invention, when the emitting linearly polarized light is horizontally linearly polarized, an optical axis of a λ/4 plate is at 45 degree counter-clockwise to the horizontally linearly polarized light.

In still another aspect of the present invention, the negative nematic liquid crystals are arranged in a circle in a clockwise or counter-clockwise direction by applying an electric field between the upper transparent electrode and the lower transparent electrode.

According to the present invention, a self-focusing liquid crystal cell comprises a first glass substrate, a upper transparent electrode, a liquid crystal layer, a lower transparent electrode and a second glass substrate. The upper transparent electrode is shaped as a semi-sphere, while the lower transparent electrode is a planar electrode, and a distance between a center of the upper transparent electrode and the lower transparent electrode is smaller than that between periphery of the upper transparent electrode and the lower transparent electrode is greater; the liquid crystal layer is stuffed with negative nematic liquid crystals.

In one aspect of the present invention, a non-conductive polymer layer, which maintains a profile of the upper transparent electrode, is set up between the upper transparent electrode and the liquid crystal layer.

In another aspect of the present invention, the negative nematic liquid crystals are arranged in a circle in a clockwise direction by applying an electric field between the upper transparent electrode and the lower transparent electrode.

In another aspect of the present invention, the negative nematic liquid crystals are arranged in a circle in a counter-clockwise direction by applying between the upper transparent electrode and the lower transparent electrode.

In yet another aspect of the present invention, when the emitting linearly polarized light is perpendicularly linearly polarized, an optical axis of a λ/4 plate is at 45 degree clockwise to the perpendicularly linearly polarized light.

In yet another aspect of the present invention, when the emitting linearly polarized light is horizontally linearly polarized, an optical axis of a λ/4 plate is at 45 degree counter-clockwise to the horizontally linearly polarized light.

In still another aspect of the present invention, the negative nematic liquid crystals are arranged in a circle in a clockwise or counter-clockwise direction by applying an electric field between the upper transparent electrode and the lower transparent electrode.

In contrast to the technical problem occurring in the prior art that the LCD of grin lens is unable to adjust its focal length depending on the viewer's position, the present invention proposes a self-focus liquid crystal cell and corresponding LCD are equipped with the liquid crystal lens controlled by applied voltage and the use of λ/4 plates, which dynamically adjusts the focal length of the liquid crystal lens so as to provide the consistent variation of the gradient refractive index from all angles of view.

These and other features, aspects and advantages of the present disclosure will become understood with reference to the following description, appended claims and accompanying figures.

### BRIEF DESCRIPTION OF THE DRAWINGS

FIG. 1 shows a schematic diagram of a grin lens of a gradient variation of refractive index according to the prior art.

FIG. 2 shows a schematic diagram of a self-focusing liquid crystal cell according to a preferred embodiment of the present invention.

FIG. 3 shows a distribution of liquid crystal of the self-focusing liquid crystal cell in a horizontal plane according to a preferred embodiment of the present invention.

FIG. 4 shows alignments of liquid crystals applied by an electric field at the cross-section view of line AB in FIG. 3.

FIG. 5 shows equivalent refractive index relating to the liquid crystal applied by an electric field at the cross-section view of line AB in FIG. 3.

FIG. 6 shows alignments of liquid crystals applied by an electric field at the cross-section view of line CD in FIG. 3.

FIG. 7 shows equivalent refractive index relating to the liquid crystal applied by an electric field at the cross-section view of line CD in FIG. 3.

FIG. 8 shows a schematic diagram of the preferred embodiments of the LCD according to the present invention.

FIG. 9 shows a mechanic diagram of the linearly polarized light, passing through the λ/4 plate, transformed into the circularly polarized light, when the linearly polarized light emitted from the LCD of the preferred embodiment of the present invention is perpendicularly linearly polarized.

FIG. 10 shows a mechanic diagram of the linearly polarized light, passing through the λ/4 plate, transformed into the circularly polarized light, when the linearly polarized light emitted from the LCD of the preferred embodiment of the present invention is horizontally linearly polarized.

FIG. 11 shows a diagram of the liquid crystals applied by an electric field when the circularly polarized light passes through each section of the liquid crystal lens of the self-focusing liquid crystal cell.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

In all figures, units of similar structure are labeled with the same numbers.

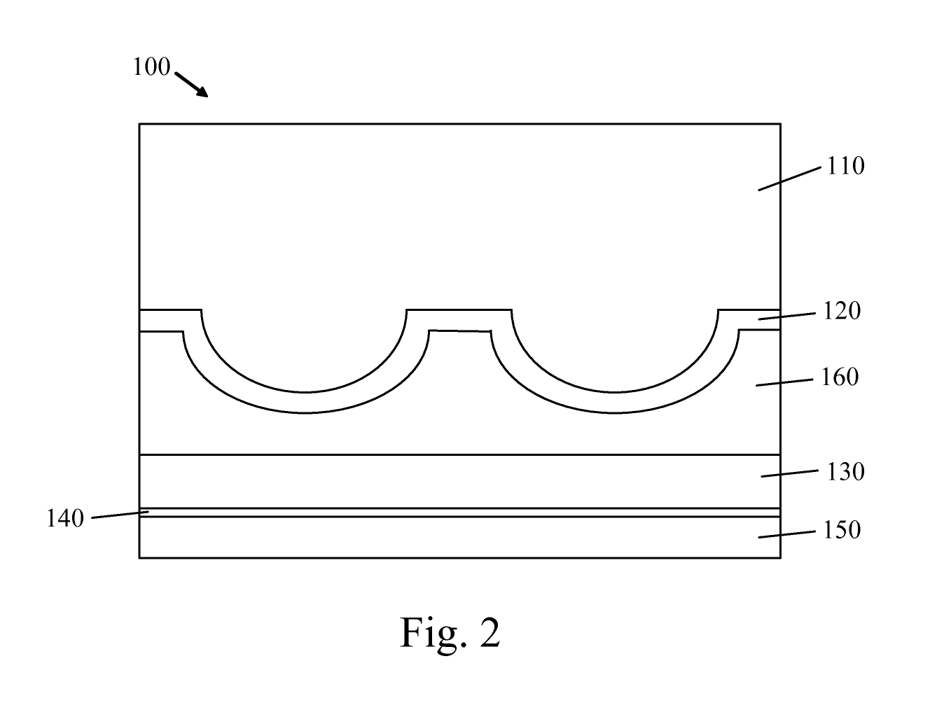

Referring to FIG. 2, a self-focusing liquid crystal cell 100 comprises a first glass substrate 110, an upper transparent electrode 120, a liquid crystal layer 130, a lower transparent electrode 140 and a second glass substrate 150.

A profile of the upper transparent electrode 120 is shaped as a semi-sphere, while the lower transparent electrode 140 is a planar electrode. A distance from a center of the upper transparent electrode 120 to the lower transparent electrode 140 is closer than that from the periphery of the upper transparent electrode 120 to the lower transparent electrode 140. The liquid crystal layer 130 is stuffed by negative nematic liquid crystals.

When the self-focusing liquid crystal cell 100 of above-mentioned structure is working, owing to the greater distance between the upper transparent electrode 120 and the periphery of the lower transparent electrode 140 and the smaller distance between the upper transparent electrode 120 and the center of the lower transparent electrode 140, a weaker electric field strength is induced in the periphery of the liquid crystal lens made of the negative nematic liquid crystals in the liquid crystal layer 130, while a stronger electric field strength is induced in the of the liquid crystal lens. The liquid crystal molecules in the liquid crystal layer 130 are aligned in a perpendicular direction (that is, the liquid crystal molecules are perpendicular to the plane of the lower transparent electrode 140), when no electric field is induced. At this moment, the incident linearly polarized light is not rotated. Only when electric field is applied between the upper transparent electrode 120 and the lower transparent electrode 140, the liquid crystal molecules are twisted horizontally (that is, in parallel with the plane of the lower transparent electrode 140), thereby rotating the incident linearly polarized light. A non-conductive polymer layer 160 between the upper transparent electrode 120 and the liquid crystal layer 130 maintains the profile of the upper transparent electrode 120. As a result, the distance between the upper transparent electrode 120 and the liquid crystal layer 130 are properly maintained, which means the greater distance between the upper transparent electrode 120 and the periphery of the lower transparent electrode 140 and the smaller distance between the upper transparent electrode 120 and the center of the lower transparent electrode 140 are also well kept.

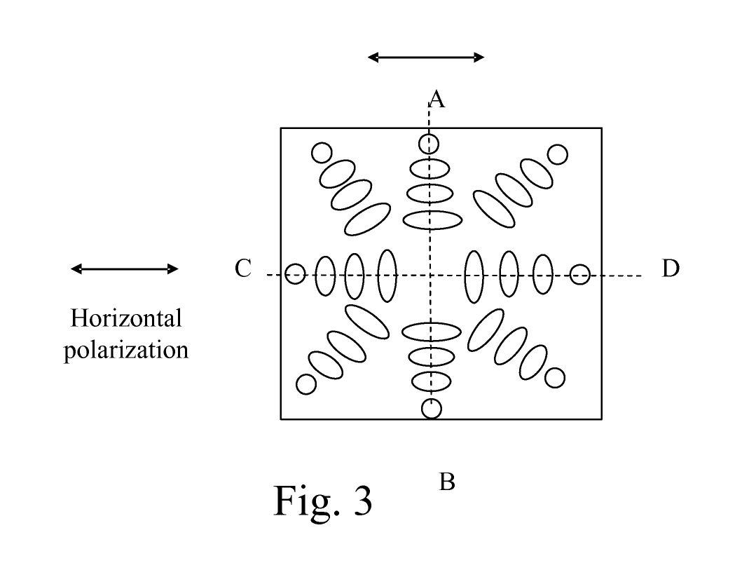

FIG. 3 shows a top view of a unit structure in FIG. 2. FIG. 3 shows distribution of liquid crystals while the self-focusing liquid crystal cell 100 is working. The unit structure comprises the semi-sphere upper transparent electrode 120, the lower transparent electrode 140, the first glass substrate 110, the second glass substrate 150, and the corresponding liquid crystal layer 130. As shown in FIG. 3, the negative nematic liquid crystals are arranged in a circle in a clockwise direction or a counter-clockwise direction by applying the electric field between the upper transparent electrode 120 and the lower transparent electrode 140.

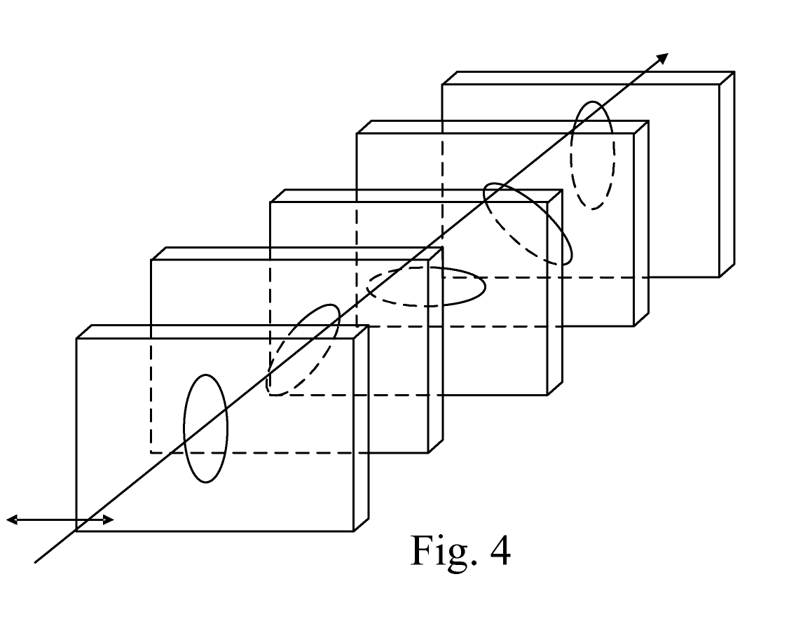

Referring to FIG. 4 to FIG. 7, it is shown how incident light, by passing through the voltage-determined liquid crystal lens between the upper transparent electrode 120 and the lower transparent electrode 140, performs the gradient variation of refractive index of the grin lens.

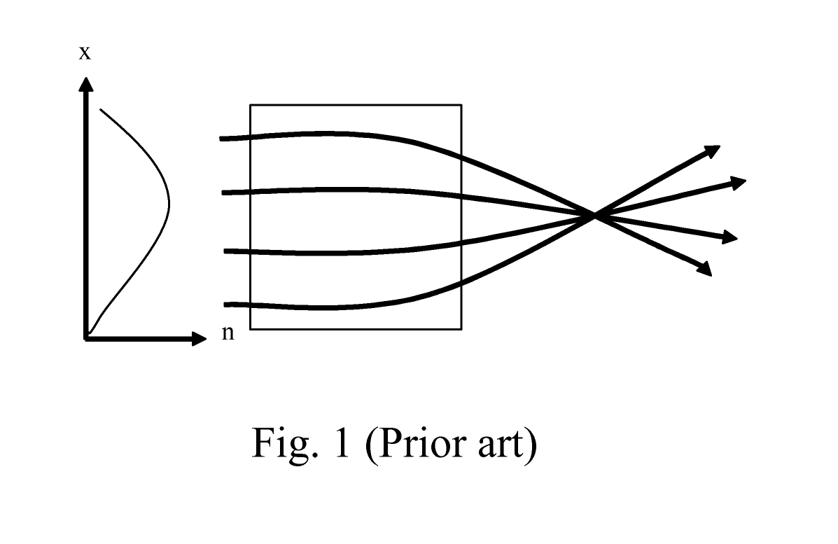

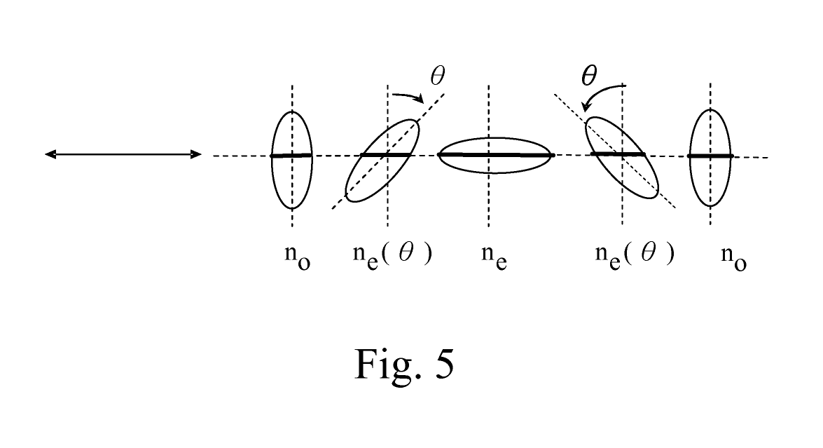

FIG. 4 shows a position diagram of the liquid crystal, tilted owing to electric field, at the section AB in FIG. 3. The direction of horizontal polarization is perpendicular to the progress direction of the incident light. The incident light is affected by liquid crystals at various tilts at the section AB. FIG. 5 shows equivalent refractive index of the liquid crystal tilted in electric field at the section AB in FIG. 3. The horizontal polarized light, which is perpendicular to the progress direction of the incident light, is affected by a series of layered liquid crystal molecules driven by voltage between the upper transparent electrode 120 and the lower transparent electrode 140. The equivalent refractive indices of the layered liquid crystal molecules in the direction of horizontal polarization at the section AB are nₒ, nₑ(θ), nₑ, nₑ(θ), nₒ, respectively. These refractive indices meet the relation of refractive index nₑ>nₑ(θ)>nₒ, in which nₒ refers to ordinary refractive index, nₑ refers to extraordinary refractive index, and nₑ(θ) falls between ordinary refractive index and extraordinary refractive index. Accordingly, the horizontal polarized incident light which is perpendicular to the progress direction of the incident light at the section AB meets the altering module of the gradient refractive index of the grin lens in FIG. 1. Also, the gradient refractive index is adjustable according to the voltage applied between the upper transparent electrode 120 and the lower transparent electrode 140, which dynamically adjusts the focal length of the liquid crystal lens, in order to realize gradient variation of the refractive index of the grin lens.

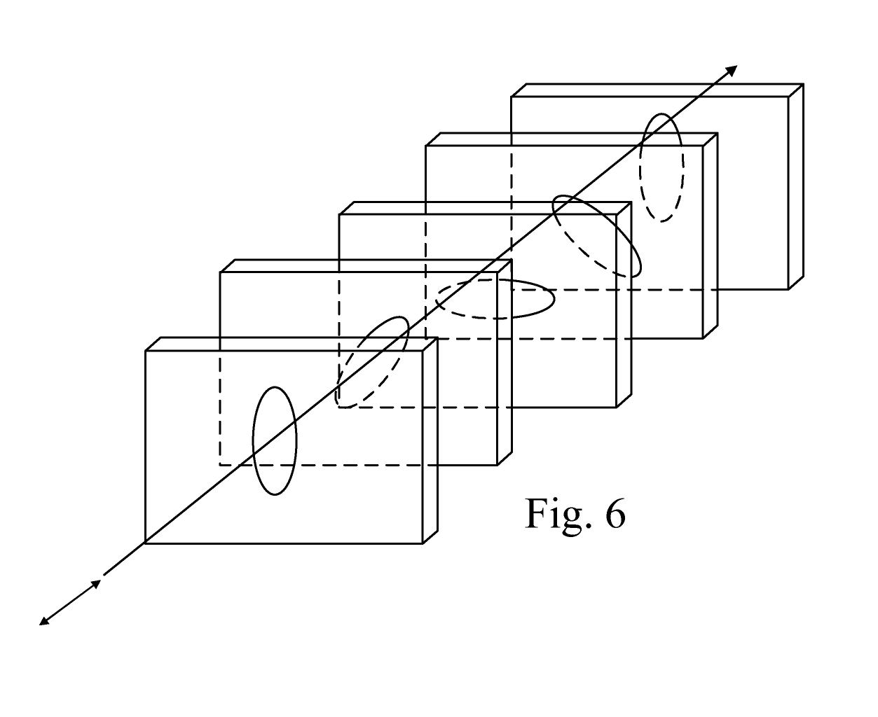

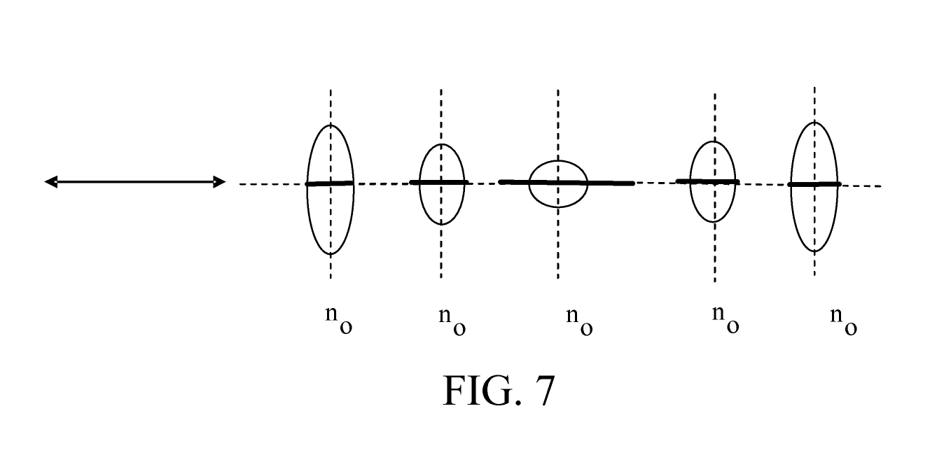

FIG. 6 shows a position diagram of the liquid crystal, tilted owing to electric field, at the section CD in FIG. 3. The direction of horizontal polarization is parallel with progress direction of the incident light. The incident light is not affected by unchanging liquid crystals at the section CD. FIG. 7 shows equivalent refractive index of the liquid crystal tilted in electric field at the section CD in FIG. 3. The horizontal polarized light, which is perpendicular to the progress direction of the incident light, is affected by a series of layered liquid crystal molecules controlled by applied voltage between the upper transparent electrode 120 and the lower transparent electrode 140. However, the equivalent refractive indices of the layered liquid crystal molecules in the direction of horizontal polarization at the section CD are unanimously nₒ. As a result, there is no grin-lens effect for the horizontally polarized incident light parallel with the direction of the incident light at the section CD.

To sum, the self-focusing liquid crystal cell 100, with the liquid crystal lens controlled by applied voltage, dynamically adjusts the focal length of the liquid crystal lens, in order to provide the altering function of the gradient refractive index of the grin lens.

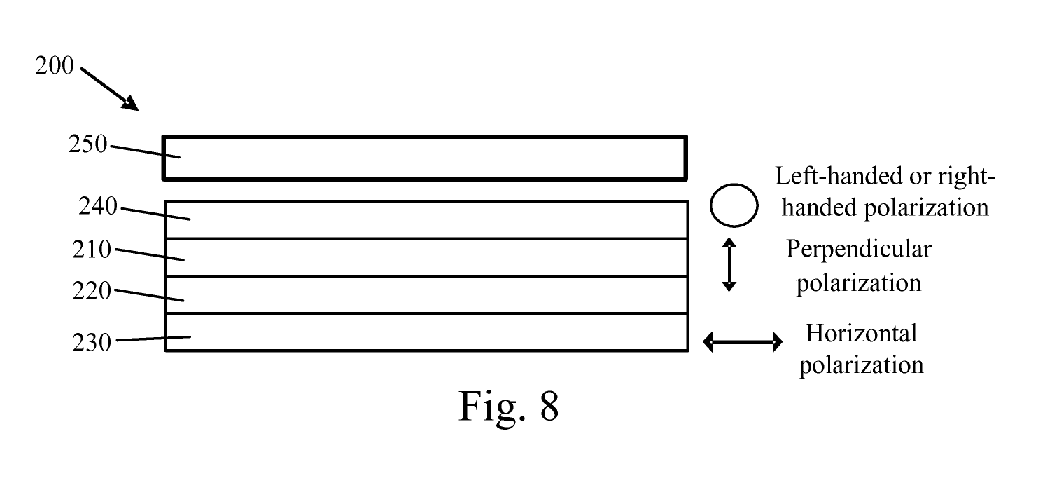

Referring to FIG. 8, the present invention also proposes an LCD 200, which comprises a first polarizer 230, a first liquid crystal cell 220, a second polarizer 210, a second polarizer 210 and a self-focusing liquid crystal cell 250. The self-focusing liquid crystal cell 250 comprises a first glass substrate, a upper transparent electrode, a liquid crystal layer, and a second glass substrate. The LCD 200 also comprises a λ/4 plate 240, located outside of a light polarizer 210, which transforms incident linearly polarized light into circularly polarized light. The incident side of the self-focusing liquid crystal cell 250 is attached to the emitting side of the λ/4 plate 240.

Combing with the self-focusing liquid crystal cell 250, which dynamically adjusts the focal length of the grin lens, the LCD 200 provides the consistent altering function of gradient refractive index of the grin lens, from all angles of view. The mechanics and benefits of the self-focusing liquid crystal cell 250 is the same as those of the above-mentioned self-focusing liquid crystal cell 100. Accordingly, an embodiment of the self-focusing liquid crystal cell 250 is referred to that of the self-focusing liquid crystal cell 100.

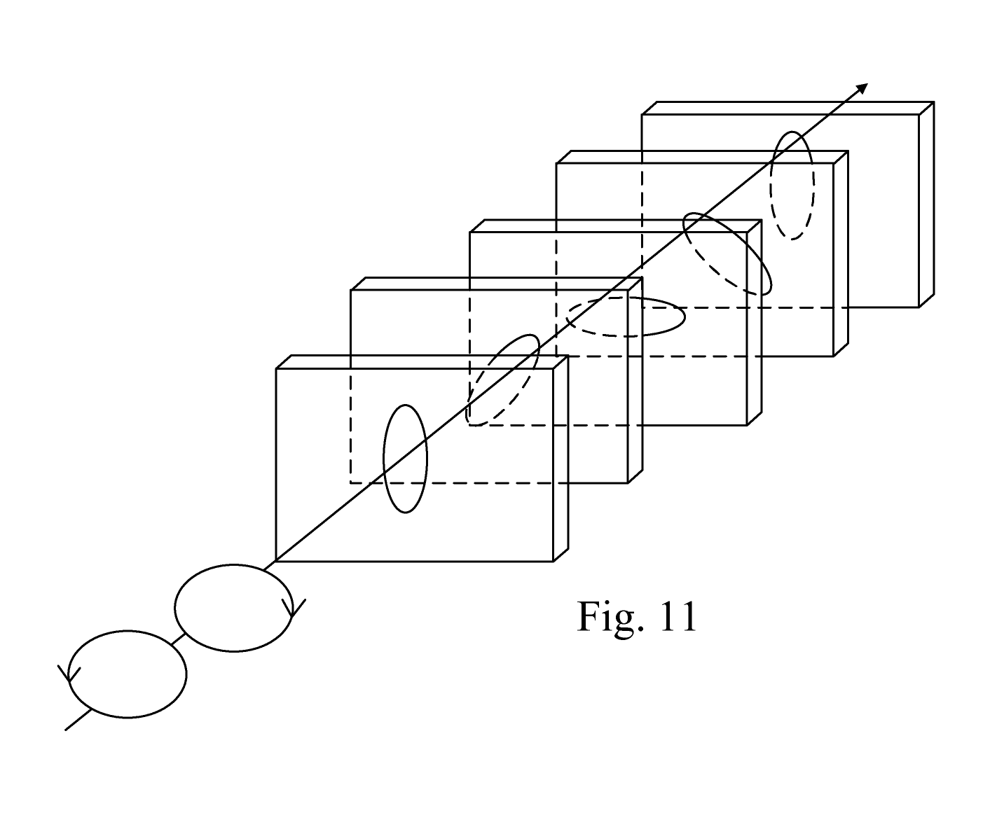

In order to provide the consistent altering function of the gradient refractive index of the grin lens from all angles of view, the LCD 200 of the present invention install the λ/4 plate 240 outside of a light polarizer 210, which transforms incident linearly polarized light into circularly polarized light. Because there is no grin-lens effect for the horizontally polarized incident light parallel with the progress direction of the incident light at the section CD, all incident linearly polarized light, through the λ/4 plate 240, transformed into circularly polarized light, and then passing through the self-focusing liquid crystal cell 250. Consequently, the consistent altering function of the gradient refractive index of the grin lens from all angles of view is attainable by the self-focusing liquid crystal cell 250. Referring to FIG. 11, the self-focusing liquid crystal cell 250 enables any linearly polarized light to attain consistent variation of refractive index from any angle of view to the liquid crystal lens, which achieves symmetry focus at any angle of view. Accordingly, there is 3D performance at any naked eye's view on condition of the same observing distance.

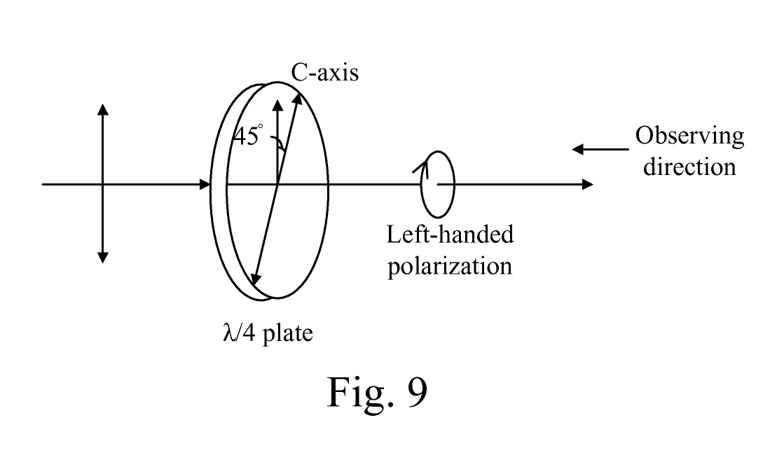

FIG. 9 shows a mechanic diagram of the linearly polarized light, passing through the λ/4 plate, transformed into the circularly polarized light, when the linearly polarized light emitted from the LCD of the preferred embodiment of the present invention is perpendicularly linearly polarized. When the incident light is perpendicularly linearly polarized, the optical axis c of the λ/4 plate 240 and the perpendicularly linearly polarized light forms an angle of 45 degree. Observing from the emitting side, the optical axis c of the λ/4 plate is at 45 degree clockwise to the perpendicularly linearly polarized light, which makes the emitting circularly polarized light into left-handed polarized light.

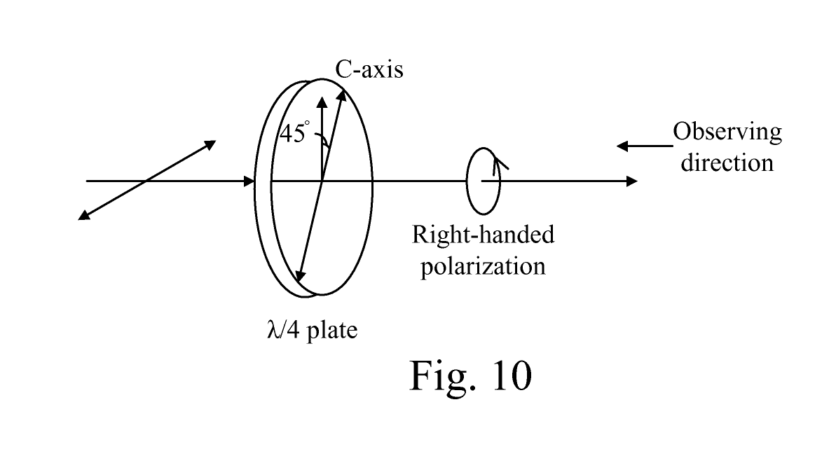

FIG. 10 shows a mechanic diagram of the linearly polarized light, passing through the λ/4 plate, transformed into the circularly polarized light, when the linearly polarized light emitted from the LCD of the preferred embodiment of the present invention is horizontally linearly polarized. When the incident light is horizontally linearly polarized, the optical axis c of the λ/4 plate 240 and the horizontally linearly polarized light forms an angle of 45 degree. Observing from the emitting side, the optical axis c of the λ/4 plate is at 45 degree counter-clockwise to the perpendicularly linearly polarized light, which makes the emitting circularly polarized light into right-handed polarized light.

FIG. 11 shows a diagram of the liquid crystals applied by an electric field when the circularly polarized light passes through each section of the liquid crystal lens of the self-focusing liquid crystal cell. The circularly polarized light is affected by liquid crystals of various tilts in each section of the liquid crystal lens. FIG. 5 shows the equivalent refractive indices of the liquid crystals tilted in electric field in each section of the liquid crystal lens. Consequently, the circularly polarized light is enabled to meet, in each direction of the section, the altering function of the gradient refractive index of the grin lens in FIG. 1. Also, the gradient refractive index is adjustable according to the voltage applied between the upper transparent electrode 120 and the lower transparent electrode 140, which dynamically adjusts the focal length of the liquid crystal lens, in order to realize the variation of the gradient refractive index of the grin lens.

Accordingly, the LCD 200 having the gradient refractive index of the liquid crystal lens, performs 3D effect from all angles of view, provides a function of switch between 2D and 3D, and dynamically adjusts the focal length of the liquid crystal lens.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A liquid crystal display (LCD), comprising a first polarizer, a first liquid crystal cell, a second polarizer, and a self-focusing liquid crystal cell, the self-focusing liquid crystal cell comprising a first glass substrate, a upper transparent electrode, a liquid crystal layer, a lower transparent electrode, and a second glass substrate, the LCD being characterized in that:
the LCD comprises a λ/4 plate, located outside of the polarizer, transforming linearly polarized light into circularly polarized light; a incident side of the self-focusing liquid crystal cell is attached to an emitting side of the λ/4 plate; the upper transparent electrode is shaped as a semi-sphere, while the lower transparent electrode is a planar electrode, and a distance between a center of the upper transparent electrode and the lower transparent electrode is smaller than that between periphery of the upper transparent electrode and the lower transparent electrode; the liquid crystal layer is stuffed with negative nematic liquid crystals;
a non-conductive polymer layer, which maintains the shape of the upper transparent electrode, is disposed between the upper transparent electrode and the liquid crystal layer;
the negative nematic liquid crystals are arranged in a circle in a clockwise direction or a counter-clockwise direction by applying an electric field between the upper transparent electrode and the lower transparent electrode;
when the emitting linearly polarized light is perpendicularly linearly polarized, an optical axis of the λ/4 plate is at 45 degree clockwise to the perpendicularly linearly polarized light;
when the emitting linearly polarized light is horizontally linearly polarized, an optical axis of the λ/4 plate is at 45 degree counter-clockwise to the horizontally linearly polarized light.

2. An LCD, comprising a first polarizer, a second polarizer and a self-focusing liquid crystal cell; the self-focusing liquid crystal cell comprising a first glass substrate, a upper transparent electrode, a liquid crystal layer, a lower transparent electrode and a second glass substrate, the LCD being characterized in that:
the LCD comprises a λ/4 plate, located outside of the polarizer, transforming linearly polarized light into circularly polarized light; an incident side of the self-focusing liquid crystal cell is attached to an emitting side of the λ/4 plate; the upper transparent electrode is shaped as a semi-sphere, while the lower transparent electrode is a planar electrode, and a distance between a center of the upper transparent electrode and the lower transparent electrode is smaller than that between periphery of the upper transparent electrode and the lower transparent electrode is greater; the liquid crystal layer is stuffed with negative nematic liquid crystals.

3. The LCD of claim 2, characterized in that: a non-conductive polymer layer, which maintains a profile of the upper transparent electrode, is set up between the upper transparent electrode and the liquid crystal layer.

4. The LCD of claim 2, characterized in that: the negative nematic liquid crystals are arranged in a circle in a clockwise direction by applying an electric field between the upper transparent electrode and the lower transparent electrode.

5. The LCD of claim 2, characterized in that: the negative nematic liquid crystals are arranged in a circle in a counter-clockwise direction by applying between the upper transparent electrode and the lower transparent electrode.

6. The LCD of claim 2, characterized in that: when the emitting linearly polarized light is perpendicularly linearly polarized, an optical axis of a λ/4 plate is at 45 degree clockwise to the perpendicularly linearly polarized light.

7. The LCD of claim 2, characterized in that: when the emitting linearly polarized light is horizontally linearly polarized, an optical axis of a λ/4 plate is at 45 degree counter-clockwise to the horizontally linearly polarized light.

8. The LCD of claim 3, characterized in that: the negative nematic liquid crystals are arranged in a circle in a clockwise or counter-clockwise direction by applying an electric field between the upper transparent electrode and the lower transparent electrode.

9. A self-focusing liquid crystal cell comprising a first glass substrate, a upper transparent electrode, a liquid crystal layer, a lower transparent electrode and a second glass substrate, the self-focusing liquid crystal cell being characterized in that:
the upper transparent electrode is shaped as a semi-sphere, while the lower transparent electrode is a planar electrode, and a distance between a center of the upper transparent electrode and the lower transparent electrode is smaller than that between periphery of the upper transparent electrode and the lower transparent electrode is greater; the liquid crystal layer is stuffed with negative nematic liquid crystals.

10. The self-focusing liquid crystal cell of claim 9, characterized in that: a non-conductive polymer layer, which maintains a profile of the upper transparent electrode, is set up between the upper transparent electrode and the liquid crystal layer.

11. The self-focusing liquid crystal cell of claim 9, characterized in that: the negative nematic liquid crystals are arranged in a circle in a clockwise direction by applying an electric field between the upper transparent electrode and the lower transparent electrode.

12. The self-focusing liquid crystal cell of claim 9, characterized in that: the negative nematic liquid crystals are arranged in a circle in a counter-clockwise direction by applying between the upper transparent electrode and the lower transparent electrode.

13. The self-focusing liquid crystal cell of claim 9, characterized in that: when the emitting linearly polarized light is perpendicularly linearly polarized, an optical axis of a λ/4 plate is at 45 degree clockwise to the perpendicularly linearly polarized light.

14. The self-focusing liquid crystal cell of claim 9, characterized in that: when the emitting linearly polarized light is horizontally linearly polarized, an optical axis of a λ/4 plate is at 45 degree counter-clockwise to the horizontally linearly polarized light.

15. The self-focusing liquid crystal cell of claim 10, characterized in that: the negative nematic liquid crystals are arranged in a circle in a clockwise or counter-clockwise direction by applying an electric field between the upper transparent electrode and the lower transparent electrode.
